(19) United States
(12) Patent Application Publication
(10) Pub. No.: US 2006/0199575 A1
(43) Pub. Date: Sep. 7, 2006

(54) Customized ringtones and method for their production

(76) Inventors: Jeffrey Moore, Seattle, WA (US); Ian Eisenberg, Seattle, WA (US); Paul D'Oley, Seattle, WA (US)

Correspondence Address: John P. Luther;c/o Newman & Newman LLP, Suite 610, 505 Fifth Avenue South, Seattle, WA, 98104, US

(21) Appl. No.: 11/070,535

(22) Filed: Mar. 1, 2005

(51) Int. Cl. H04M 3/00

(52) U.S. Cl. 455/418; 455/567

(57) ABSTRACT

The present invention relates to the production of custom made ringtones for use with both mobile wireless phones and wireline phones.

### COPYRIGHT NOTICE

Copyright 2005 Blue Frog Mobile, Inc. All right reserved. A portion of the disclosure of this patent application/patent disclosure and/or document contains material which is subject to copyright protection. The copyright owners have no objection to the facsimile reproduction by anyone of this document or a patent which issues therefrom as it appears in the United States Patent and Trademark Office file or records.

### FIELD OF THE INVENTION

The present invention relates to the production of customized ringtones for use with mobile phone and wireline phone devices from user recorded sounds, noises, voices, audible text, music, and tones and the like and various combinations thereof, and optionally in conjunction with graphics.

### BACKGROUND OF THE INVENTION

Telephone devices, and particularly mobile phones, have evolved in recent years to encompass a variety of functions and different features with mobile radio terminals of the mobile telephone type generally including a display screen, a keypad with various keys, a memory, such as for temporarily storing one or more SMS messages received from a network, processing equipment to operate the keys and memory and the display screen in which SMS messages are viewed after actuation of one or more keys.

One of a telephone's more distinguishing features (or that of its user/operator) is its ringtone which alerts a user to the reception of an incoming call or an SMS message. Many mobile phone devices, such as cell phones, recently available are provided with a memory-bound selection of different ringtones, such as popular tunes or musical scores and the like, or perhaps variations of traditional telephone rings in an attempt to appeal to the personalized tastes of the various users. Thus, at least to a limited degree, with the purchase or otherwise acquiring of a cell phone users or subscribers are offered the facility to customize their ringtones from a pre-manufactured selection. Once a ringtone has been selected from the mobile telephone's limited library of those pre-stored in its memory, however, alternative selections are but a few.

More options have become available recently which permit a user to download a desired ringtone from a large selection available on different web sites on the Internet. This is accomplished by a user receiving a type of SMS message called a “Smart Message” which may contain a ringtone of choice, and which oftentimes enables access to other products or services, such as, for example, wallpaper themes and designs, chat lines or games and the like. Usually a fee is paid for access to a new ringtone available from such a service.

Such personalized ringtones have become widely popular as they permit users to differentiate their cell phones from others and to distinctly personalize their tastes, and such may also be used to identify a particular calling party, for example, for screening purposes. For example, In U.S. patent application publication No. 20040081305 there is disclosed a ringtone system for a called party that wishes to have a particular ringtone annunciated for each of several types of calls from calling parties. See also, for example, U.S. Patent Application Publication No. 20040180700 which describes a subscriber identity module for use in a mobile radio terminal which is able to provide information relating to incoming calls from a network to distinguish calls from friends or business contacts and the like, or otherwise for filtering purposes. The module is also able to distinguish for its user incoming calls from incoming SMS messages.

Customized ringtones are also now available for both wireless and wireline phones alike. See, for example, U.S. Patent Application Publication No. 20040109588 which discloses a ringtone module enabling a user to customize ringtones for wireline telephones, with options ranging from the selection of a desired ring tone based upon the time of day, the day of the week, the calling telephone number, or any other user-identified criteria, or otherwise allows a user to select from a library of ringtones and to specify conditions of use for each.

As one may ascertain, however, no matter what new service is implemented and/or employed, the user is still offered only a selection from a variety of pre-fabricated ringtones from a necessarily limited library. Such ringtones will always be made by someone else and not the user. It would be highly desirable, therefore, to provide users or subscribers the option of creating or fabricating their very own personalized ringtones, preferably with the added options to customize and change ringtones at will and to associate their custom-made ringtones with any phone number as desired, for the ultimate in ringtone customization and individuality of expression.

### SUMMARY OF THE INVENTION

Fulfilling such desires and long felt needs as described above, the present invention provides a method and system enabling subscribers and users of both mobile telephones, such as cell phones, and wireline phones the not heretofore available ability to create and fabricate at will their very own and personalized ringtones as frequently as desired, and for whatever telephone number is desired. The inventive method and system may be employed with any protocol as desired including SMS, EMS and MMS which allows for the transmission of text, sounds, images and video. This novel method and system also provides a variety of distinct and important advantages in various business methods, functions and endeavors not heretofore available.

The invention is more fully understood and described with reference to the following detailed discussion of preferred embodiments with reference to the accompanying drawings.

### BRIEF DESCRIPTION OF THE DRAWINGS

FIG. 1 is a flow diagram generally outlining the steps of one embodiment of use of the present invention within a wireless or wireline telecommunications system.

FIG. 2 is a more detailed flow chart outlining the steps involved in an embodiment of the present invention operating within a wireless or wireline telecommunications system.

FIG. 3 is a block diagram of an embodiment of the inventive ringtone fabrication method and system residing within a computer system.

FIG. 4 is a schematic drawing of an embodiment of the present invention operating within a telecommunications system.

### DETAILED DISCUSSION OF PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor or the present disclosure.

In the following discussion, many specific details are provided to set forth a thorough understanding of the present invention. It will be obvious, however, to those skilled in the art that the present invention may be practiced without specific details, and in some instances of this discussion with reference to the drawings known elements have not been illustrated in order not to obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be preformed in either hardware or software, or some combination thereof. In some preferred embodiments the functions are performed by a processor such as a computer or an electronic data processor in accordance with code, such as computer program code, software, and/or integrated circuits that are coded to perform such functions.

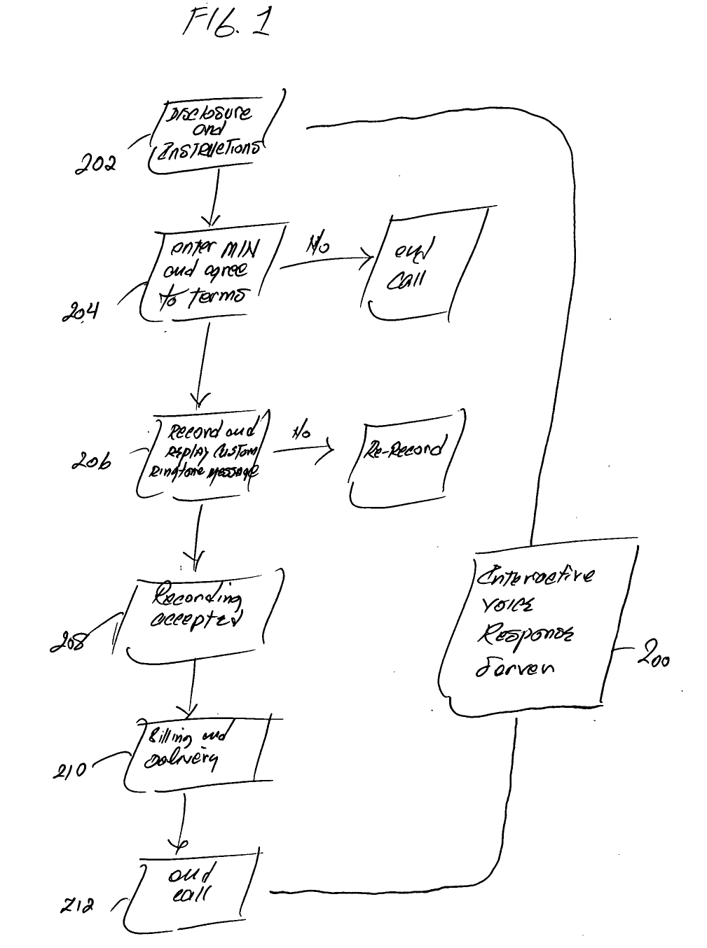

Having thus prefaced this discussion, the present invention provides a method and system which enables mobile telephone users and wireline users and/or subscribers alike with the ability to create or fabricate their own custom ringtones at will and as frequently as desired for use with one's personal phone, or the phones of others associated with any telephone number as desired be it a wireless or wireline device. As generally shown in FIG. 1, a telecommunications carrier, such as T-Mobile, Verizon, Cingular, AT&T or Sprint and the like, whether wireless or wireline, having the capability of implementing the inventive method and system is employed by a user or subscriber to place a telephone call from either a wireless device, such as a cell phone, or from a wireline telephone to a service or vendor enabling the inventive method and system, by way of, for example, an advertised telephone number. The call is placed to a service network which operates the inventive method and system as implemented by the utilization of a specifically developed software program(s) supported by an Interactive Voice Response (“IVR”) interface, by suitable data structures, servers and by appropriate Application Specific Circuits (“ASC”). In FIG. 1, which illustrates but one of many possible embodiments useful with this invention, a user contacting the service or service vendor by way of an IVR 200 may be met with a greeting and/or disclosure of the service 202, and may also be provided with a set of instructions enabling use of the service. At some point the user will be requested to enter a Mobile Identification Number (“MIN”) 204 which uniquely identifies the user's mobile unit, or another's unit, within a carrier's network. The user may also be requested to agree to certain terms in order to use the personal ringtone fabrication service. Next, for example, after agreeing to proposed terms of use, preferably the user is prompted to record his or her custom-made ringtone over the phone 206. The self-made ringtone may be composed of or from virtually anything that the user desires, and may be, for example, without limitation, a portion of an audible text, a person's or persons' voices, a musical score, a jingle, for example, such as from a well known advertisement, sounds and/or tones, such as animal sounds, the sound of a storm or of the ocean, noises, such as breaking glass or a fire alarm or a person breaking wind, or any combination thereof. Preferably, the thus created new ringtone may be played back by the user, or for the user, one or more times and/or a new ringtone created from user inputed content to the ultimate satisfaction of the service user, such as indicated in step 204. The IVR 200 thereafter processes the user's newly created ringtone for implementation in the user telephone's memory, or other's telephonic memory, as the case may be, for example, in the case of a mobile phone by way of an SMS message or EMS or MMS message with the user downloading the ringtone content by way of a WAP site for installation in the memory of the phone device effective to function as a custom made ring tone. The service may then proceed with billing before or after this event, as shown in step 210, at which point the call ends and the service transaction is consummated 212.

As shown in the example below there is illustrated an embodiment of an instructional and dialog scheme which might be employed with the present inventive method and system in enabling a service user to use the service in creating their own personalized ringtone and having it installed on their (or another's) phone device. Upon calling the service's IVR 300, a user may be greeted as follows:

### EXAMPLE 1

I. Welcome to Own Tones™ where you can create your very own personalized ‘BLING IN YOUR RING’™ ringtone. Send the ringtone to a friend or keep it for your own personal use!

II. You must be calling from your cellular phone to use this service (or follow XXX instructions for use with a wireline service). The cost of this service is $:'#ˆ! per personalized ringtone and will be billed directly to your cellular telephone. This service assumes no responsibility or liability for transmission failures due to user error or phone incompatibility. For a full list of currently compatible phones please refer to our website, hhtp://createyourownringtones.com.

III. To get started and record your ringtone, press 1. For more information and disclaimers, press 2. To leave a comment or suggestion press 3. Press 0 to repeat these choices.

IV. In just a moment, you will be asked to enter the cellular phone number where you wish to receive your personalized ringtone. By entering this number, you agree to pay for all charges.

V. Please select your carrier:
For T-Mobile press 1
For AT&T press 2
For Cingular press 3
For Sprint press 4

VI. Please enter the cellular phone number after the tone. Please enter all ten digits, which will include your area code. Press # when finished. This is your MIN, or Mobile Identification Number.

VII. The MIN you have entered is XXXXXXXXXX. If correct, press 1. Please press 2 to reenter your MIN.

VIII. It is now time to record your personalized ringtone. You have XX seconds to record your personalized ringtone, which may be any sound you can think of, such as music, audible text, people talking, animal noises, sexual noises, impersonations, tones, nature sounds and the like. After the tone please begin speaking or recording your choice of ringtone content.

IX. To replay the ringtone you have just recorded, please press 1. To delete and record another ringtone please press 2. To save your recorded ringtone and accept, please press 3.

X. Thank you. In just a few moments you will receive an SMS text message (or MMS message) to XXX-XXX-XXXX providing you with complete instructions on how to download your personalized ringtone. Thank you for your purchase of your BLING IN YOUR RING ringtone. For customer service contact

To further illustrate the invention, some scenarios of its use are presented below in the following examples:

### EXAMPLE 2

Eric purchases a new Motorola V600 from T-Mobile. He then decides that he wants a customized ringtone for his girlfriend Sally. Not satisfied with the offerings on his T-zones deck, Eric decides to have Sally call Blue Frog Mobile MY TONE™ service. Sally dials XXX-XXX-XXXX to receive a set of simple instructions, and as requested enters the destination telephone number and then creates a new ring tone in her own voice, such as “Hey Eric, it's your girl Sally, will you pick up the phone now sexy boy”. Upon approving or revising her message the service sends the custom content ringtone to the chosen cellular number, or MIN. Eric then retrieves the content and assigns the newly created ringtone to Sally's contact entry.

### EXAMPLE 3

Bill's cell phone is constantly ringing. He would like to be able to quickly identify or screen a call, such as by a caller's voice. Bill has his friends and co-workers each call into Blue Frog Mobile MY TONE system. His supervisor Mark dials XXX-XXX-XXXX and follows directions. He then creates a ringtone as follows: “Hey Bill, get back to work”. Upon approving or revising his message, they inventive system sends the custom content ringtone to the chosen cellular number. Bill then retrieves the content and assigns the ringtone to Mark's contact entry.

### EXAMPLE 4

Mary has heard about Blue Frog Mobile's MY TONE service and decides she wants a custom ring tone for her phone, not being satisfied with the offering on her M mode deck. After calling Blue Frog's MY TONE service at XXX-XXX-XXXX she is offered simple instructions, enters the destination phone number as instructed, and creates a new ring tone by having her pet lamb BAAAAAAAA into the head set. Not being satisfied with this recording, she then re-records the sound again in accordance with the instructions set out, for example, in Example 1. Upon approving her message, the system sends the custom content ringtone to the chosen cellular number. Mary then retrieves the content of the message and assigns the “personalized” custom made ringtone to her home phone.

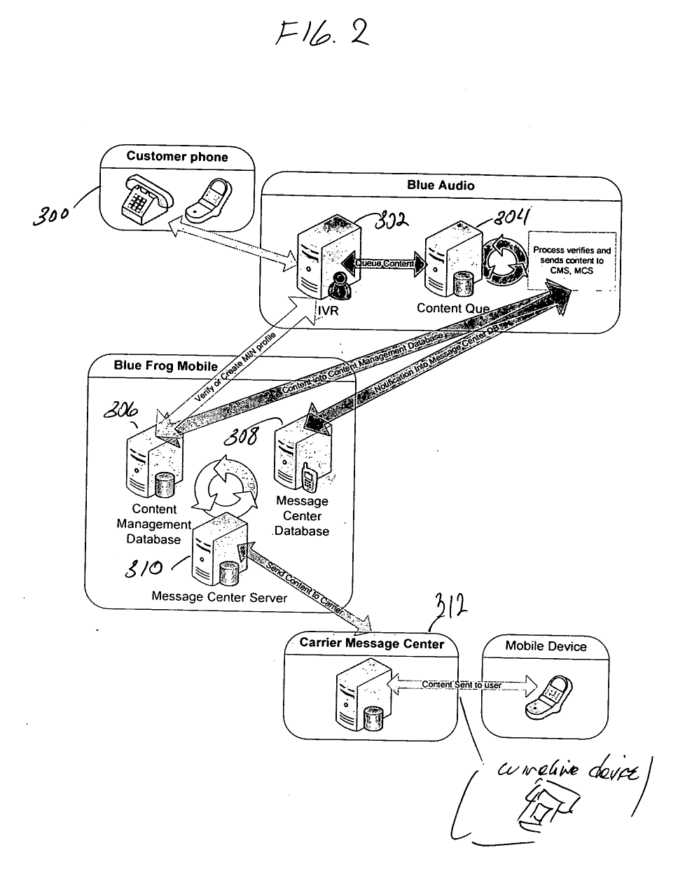

Referring now to FIG. 2, there is shown a more detailed schematic diagram in an embodiment of how the inventive method and system may be implemented. As shown, a user cell phone or wireline phone 300 initially calls the service's or service vendor's IVR 302, and is requested, for instance, to follow instructions, such as being prompted to record a greeting, sounds, tones, or a combination thereof in a manner such as exemplified above to produce a customized or custom made ringtone. After deciding upon the content of a custom fabricated ringtone, a Content Que 304 processes the received information from the IVR 302, and after conversion of its content to an appropriate format verifies and sends the content of the newly created custom made ringtone to a Content Management Database (“CMS”) 306 for memory storage, and which is readied to be played from Message Center Database (“MCD”) 308, all of which may be found as components in a Message Center Server (“MCS”) 310. This server may then correspond with a Carrier Message Center (“CMC”) 312 interface to forward the custom made ringtone via an SMS message (or MMS message) to be downloaded from a WAP site (not shown) for installation in the memory of a phone device 314, such as a wireless or wireline phone, for which a telephone number or MIN has been designated.

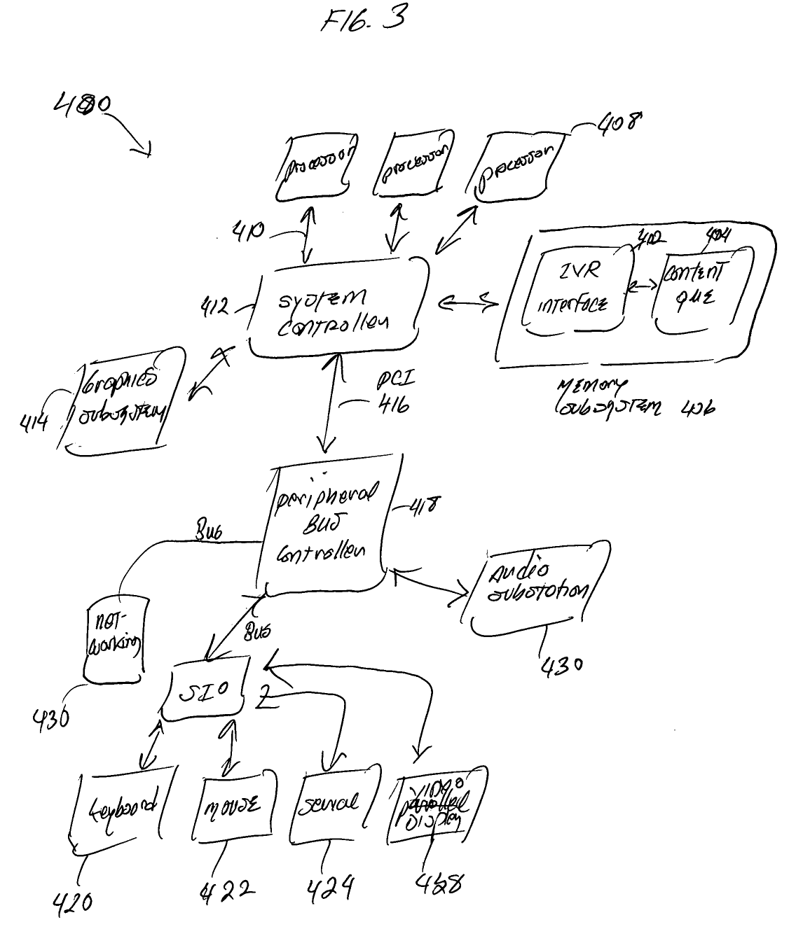

Referring now to FIG. 3 there is illustrated a block diagram of the inventive ringtone fabrication method and system residing within a Computer System 400. As an example, an IVR 402 and Content Que 404 are shown in operable communication, for example, via a bus (not shown), with a Memory Subsystem 406, and may also interface with a flash memory or peripheral storage device (not shown). The computer system 400 has one or more Central Processors 408 executing an operating system which is provided with a set of instructions, such as computer program code, that control the internal functions of computer system 400. A system Bus 410 communicates signals, such as data signals, control signals, address signals and the like, between the Central Processor 408 et al. and a System Controller 412. The System Controller 412 provides a bridging function between one or more Central Processors 408 et al., and optionally a Graphic Subsystem 414, Memory Subsystem 406 storing user recorded and fabricated ringtones, and a Peripheral Control Interface Bus 416, which is operated by a Peripheral Bus Controller 418. Peripheral Bus Controller 418 is an integrated circuit which serves as an input/output hub for various peripheral ports, which may include, for instance, a Keyboard port 420, a Mouse port 422, a Serial port 424 and/or a port for a Video Display unit 428, and a networking port 430. The Peripheral Bus Controller 418 may also include an Audio Substation 432. This illustrated system is but one of several configurations which may be employed in operation of the inventive method and those of ordinary skill in the art will readily understand that any of the programs, processes, methods, and systems illustrated herein may be operated by a variety of computer systems and hardware.

The Memory Substation 406 (and/or flash memory or peripheral storage devices) may also contain an applications program which cooperates with the operating system, and optionally a Video Display unit 430 to provide a graphical user interface. The graphical user interface may include a combination of signals communicated via Key Board port 420 and Mouse port 422, and provides a visual and/or audible interface with the user of the Computer System 400.

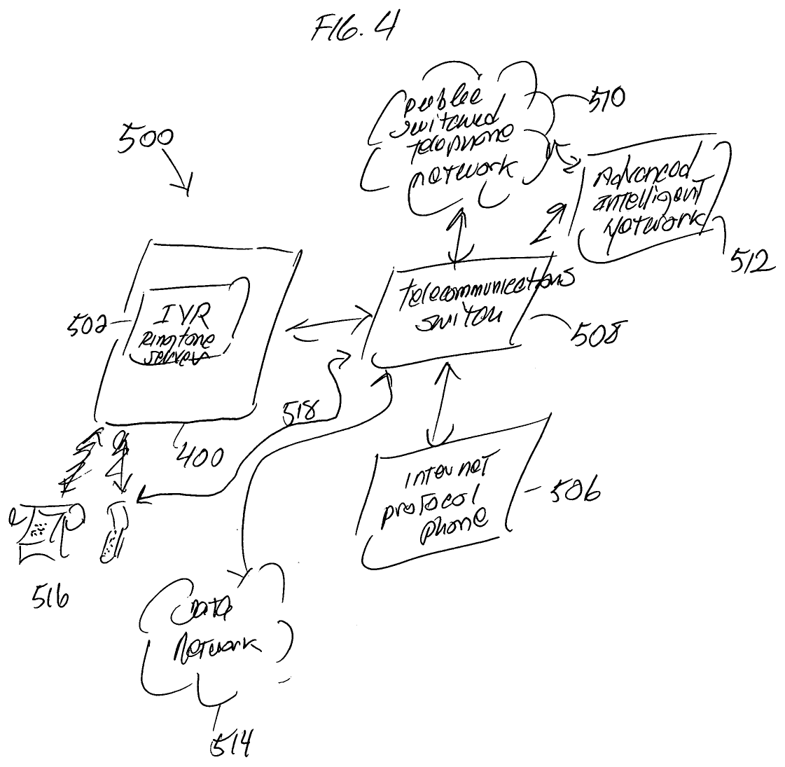

As shown in FIG. 4, there is provided a schematic drawing of an embodiment of the ringtone fabrication method and system operating system operating within a Telecommunications System 500. IVR/ring tone server 502 operates in communication with the memory, such as a memory substation or flash memory, or peripheral device as shown in FIG. 3, of a Computer System 400. IVR 502 may also operate, for example, in communication with the memory of an Internet Protocol (IP) phone 506. The Telecommunications System 500 includes a Telecommunications Switch 508 of a Public Switched Telephone Network 510. The Telecommunications Switch 508 may include an Advanced Intelligent Network (AIN) componentry 512 which controls features of the Telecommunications Switch 508. Telecommunications Switch 508 may also include a packet-based “softswitch” which uses software control to provide voice data and video services. The Computer System 400 may also interface with a Data Network 514 via an operational connection to Telecommunications Switch 500. As further shown in FIG. 4, a wireless or wireline telephone 516 by way of a WAP site (not shown) communicates with Telecommunications Switch 508, with the wireline connection using, for example, a cable/DSL modem. Packetized data messages are then received by the Computer System 400 from Data Network 514 by way of telephone connection 518 to the Telecommunications Switch 508 when telephone 516 receives an incoming call through connection 518 to Telecommunications Switch 508. The user-recorded/fabricated ringtones may then be downloaded by way of the Data Network 514 from IVR/ring tone-server 502, which out put is stored and operates within the memory of Computer System 400. As also shown in this illustration, the IVR/ring tone server enables the establishment of user recorded/fabricated ringtones for telephone 516 which interacts with Computer System 400 to store a custom fabricated ringtone for use with telephone 516.

The present invention is also applicable to Multimedia Messaging (“MMS”) systems and procedures. As known, MMS as used in mobile communications networks denotes the latest approach for transmitting messages having a multimedia content and is oftentimes described as the most recent extension of SMS and EMS messaging protocol. MMS messaging allows messaging between different mobile users and/or between mobile users and the Internet via an e-mail address. Unlike SMS messaging, MMS can include not just text, but also sound, images and video. Formats that can be embedded with MMS include text formatted with fonts, colors and the like, images (JPEG, GIF format and animator GLF), audio (MP3, WHV, AMR, MIPI) and video (MPEG and Real Media) and various combinations thereof. Images may be downloaded from WAP sites, for example, as selected from a menu within a phone, or may be, for instance, photos from a built in camera in the phone which are now commonplace, with MMS capable phones first appearing in 2002. The present invention also contemplates the employ of Enhanced Messaging Service (“EMS”), a type of halfway service between SMS and MMS which enables some features of MMS capability, such as text, some simple pictures and audio, such as the inventive self-composed ringtones, and some simple graphics and animation. MMS is a store and forward messaging service which allows mobile subscribers the ability to exchange multimedia messages with other mobile subscribers—that is, the ability to send multiple media in a single message and to send the message to multiple recipients.

A MMS message can be created, for example, by using a built-in or accessory camera, or it may be composed of sound and/or images previously stored in the mobile phone, such as downloaded from an internet web site. Without a phone even being turned on, a MMS message can be stored and forwarded to a recipient as soon as the phone is turned on. Additionally, one or a multiple of MMS messages may be stored in a user's handset and reviewed or forwarded at a later date. Further, unlike an SMS message which is limited to 160 bytes, an MMS message is a single entity as opposed to a collection of attachments and has no size limit with the possibility of being many Kbytes in size. Each MMS message contains a number of pages with each page containing an image with text and/or audio, such as the custom made ringtones of the invention. Thus, in conjunction with the personalized inventive custom made ringtones, there may be included a full range of multimedia elements such as text, audio, video, photographs and/or animation and various combinations thereof which can be sent in a single message and downloaded in a user's phone device (or any phone device or other device as desired) through a WAP site. By way of MMS messaging, custom made ringtones of the invention may be created and installed on users' phones or any other phones associated with a desired numbers, for example, in the from of a sound enhanced animation, a “talking” picture of an acquaintance or other person or character or any other display, all of which are limited only by one's imagination in creating custom made ringtones.

As example of operation, in one embodiment, of the present invention using a compatible MMS phone, a user may take a photo and send the photo to the inventive service by way of an MMS message. The user may then, for example, add a sound clip to the photo, or the person's own voice or that of a character, such as a famous person, or a cartoon character. The MMS message with recorded audio and/or graphics will then be converted to the applicable format and directed to a number specified as desired and downloaded via a WAP site for a custom made sound-visual ringtone. On a MMS compatible phone, an MMS message will appear with a message alert, with a picture message appearing on the screen and with optional text appearing along with the image someplace on the screen and/or sound beginning to play automatically which can then be downloaded into the phone device effective to operate as a custom made visual-audio ringtone (Viso-Tone™). If the MMS message is sent a non-compatible phone, a recipient will receive an SMS message with may exclaim,
“You have been sent an MMS picture message” or 007xxx has been sent you an MMS message. To register for MMS service, call 555-xxx-xxxx if you are a SSM customer or 888-xxx-xxxx, if you are a BBBBBB customer, or call xxx-xxx-xxxx for information”( and a website perhaps provided with user access information, such as a user's name or a password with which to view the message).

As will be further appreciated by those persons skilled in the art, the present inventive method and system, inclusive of one or more embodiments of its operation through various software and hardware systems, affords distinct business advantages not previously available to vendors relating to the sale of rig tones and related services and products. In this aspect the present invention provides novel methods of conducting an array of business functions comprising, inter alia, designing, manufacturing, using, marketing, selling, licensing, and/or leasing the incentive subject matter, of developing business good will, of developing valuable trademark rights in conjunction with use thereof, and further in providing novel methods of business entity formation, such as partnerships, corporations, joint ventures and other collaborations for the purpose of exploiting the business of inventive subject matter.

While this invention has been described in connection with what is presently considered to be the most practical and preferred embodiments, it is to be understood that the invention is not to be limited to the disclosed embodiments in any way as such are merely set forth for illustrative purposes. The present inventive method and system, and methods for conducting business in general, are intended to cover an array of various modifications and equivalent arrangements, all of which are contemplated for inclusion within the scope and spirit of the disclosure and appended claims.

1. A method for fabricating a ringtones for use with wireless and wireline telephones, comprising:
receiving an incoming telephone call from a calling party to a called party;
recording a ringtone from the incoming call;
sending a data message to the calling party or other telephone number including information associated with the recorded ringtone, and whereby the recorded ringtone is installed within the memory of the calling party's telephone or other party's telephone and is effective to function as a ringtone.

2. The method of claim 1 wherein said recorded ringtone is selected from text, sounds, musical score, tones, voices, noises, photographs, pictures, graphics, animation and/or audible text and combinations thereof.

3. The method of claim 1, wherein the step of recording the ringtone includes associating the ringtone with the telephone number of the calling party.

4. The method of claim 1 wherein the step of recording the ringtone includes associating the ringtone with a telephone number other than that of the calling party.

5. The method of claim 1 wherein the step of recording a ringtone includes establishing a database of recorded ringtones.

6. The method of claim 5 which further includes a step of accessing a database of user recorded/fabricated ringtones and associating one or more ringtones in said database with the telephone number of the calling party and/or that of a telephone number of other than that of the calling party.

7. The method of claim 1 wherein the step of sending the data message includes sending the data message over a wireless connection.

8. The method of claim 1 wherein the step of sending the data message includes sending the data message to a wireless device capable of presenting the ringtone.

9. The method of claim 1 further comprising querying for an Internet Protocol address of the called party.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A computer-readable medium encoded with computer-executable instructions for performing the method recited in claim 1.

31. A computer-readable medium encoded with computer-executable components of a ringtone creation system, comprising:
a call receiver component with an input capability and a notification capability, the input capability being configured to receiving an inbound telephone call, the notification capability being configured to notify the ringtone creation system of the inbound telephone call;
a caller identifier component being configured to identify a calling party that originated the inbound telephone call;
a recording component being configured to record information presented by the calling party during the inbound telephone call; and
a transmission component being configured to transmit the recorded information to the identified calling party.

32. The computer-readable medium recited in claim 31, wherein the information presented by the calling party comprises a sound, and wherein the recorded information transmitted to the identified calling party comprises a ringtone.

33. The computer-readable medium recited in claim 31, wherein the information presented by the calling party is not a sound, and wherein the recorded information transmitted to the identified calling party comprises information sufficient for a communications device to use for announcing an incoming call at the communications device.

34. A computer-implemented method for creating a ringtone, comprising the steps of:
receiving an incoming telephone call from a calling party to a called party;
recording information presented to the called party by the calling party over the incoming call; and
creating a ringtone from the recorded information for use in conjunction with subsequent telephone calls of which the calling party is a party.

35. The computer-implemented method recited in claim 34, wherein the recorded information comprises a sound.

36. The computer-implemented method recited in claim 34, wherein the ringtone is selected from text, sounds, music, tones, voices, noises, photographs, pictures, graphics, animation and/or audible text and combinations thereof

37. A computer-readable medium encoded with computer-executable instructions for performing the method recited in claim 34.
